(19) United States
(12) Patent Application Publication
(10) Pub. No.: US 2014/0351020 A1
(43) Pub. Date: Nov. 27, 2014

(54) ESTIMATING THE TOTAL SALES OVER STREAMING BIDS

(71) Applicant: International Business Machines Corporation, Armonk, NY (US)

(72) Inventors: Benny Kimelfeld, Cupertino, CA (US); David P. Woodruff, Mountain View, CA (US)

(73) Assignee: International Business Machines Corporation, Armonk, NY (US)

(21) Appl. No.: 13/901,165

(22) Filed: May 23, 2013

(51) Int. Cl. G06Q 30/02

(52) U.S. Cl. CPC G06Q 30/0206
USPC 705/7.35

(57) ABSTRACT

A mechanism is provided for computing an estimation of maximum total sales over streaming items. Each item having an associated value is designated as an item value pair. Value ranges are established to place the item value pairs. The value ranges are distinct. Each of the item value pairs is added into the value ranges according to each of the associated values for the item value pairs. Repeated item value pairs are removed that are in the same value ranges. A number of the item value pairs is reduced in each of the value ranges respectively based on an error factor, by randomly selecting the item value pairs to remove from each of the value ranges. An estimate of a total maximum value of the bids for the item value pairs in all of the value ranges is computed based on a scale factor.

### BACKGROUND

The present disclosure relates to estimating a large dataset, and more specifically, to estimating a maximum total sales value over streaming bids.

Data mining, a field at the intersection of computer science and statistics, is the process that attempts to discover patterns in large data sets. It utilizes methods at the intersection of artificial intelligence, machine learning, statistics, and database systems. The overall goal of the data mining process is to extract information from a data set and transform it into an understandable structure for further use. Aside from the raw analysis step, it involves database and data management aspects, data preprocessing, model and inference considerations, metrics, complexity considerations, post-processing of discovered structures, visualization, and online updating.

The actual data mining task is the automatic or semi-automatic analysis of large quantities of data to extract previously unknown interesting patterns such as groups of data records (cluster analysis), unusual records (anomaly detection), and dependencies (association rule mining), etc. This usually involves using database techniques such as spatial indexes. These patterns can then be seen as a kind of summary of the input data, and may be used in further analysis, or for example, in machine learning and predictive analytics.

### SUMMARY

According to an embodiment, a method, computer program product, and apparatus are provided for computing an estimation of maximum total sales over streaming items. The method includes receiving items with associated item values as bids on the items received and individually designating each item having an associated value as an item value pair, which results in item value pairs for the items with associated values as the bids. The method includes establishing value ranges in which to respectively place the item value pairs, where the value ranges are distinct and the value ranges are respectively designated from a first value range through a last value range. The first value range is a lowest value range, the last value range is a highest value range, and other value ranges are in between the first value range and the last value range. A process is performed which includes respectively adding each of the item value pairs into the value ranges according to each of the associated values for the item value pairs, and removing repeated item value pairs that are in the same value ranges. The process includes reducing an amount of the item value pairs in each of the value ranges respectively based on an error factor, by randomly selecting the item value pairs to remove from each of the value ranges, and computing an estimate of a total maximum value of the bids for the item value pairs in all of the value ranges based on a scale factor.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a system for estimating the sum of maximum values across streaming bids according to an embodiment.

FIG. 2 illustrates an algorithm for estimating the sum of maximum values according to an embodiment, which includes:

FIG. 2A illustrating an initialize algorithm;

FIG. 2B illustrating a process item algorithm;

FIG. 2C illustrating an add item subroutine;

FIG. 2D illustrating a reduce subroutine; and

FIG. 2E illustrating a finalize algorithm.

FIG. 3 is a method for computing an estimation of maximum total sales over streaming items (such as bids for items) according to an embodiment.

FIG. 4 is a chart illustrating memory space usage recordings throughout execution of the two algorithms on the same input according to an embodiment.

FIG. 5 is a chart illustrating the memory space cost for uniform values and varying N according to an embodiment.

FIG. 6 is a chart illustrating the time cost for uniform values and varying N according to an embodiment.

FIG. 7 is a chart illustrating the memory space cost for uniform values and varying ε according to an embodiment.

FIG. 8 is a chart illustrating the time cost for uniform values and varying ε according to an embodiment.

FIG. 9 is a chart illustrating the memory space cost for Cauchy data while varying N according to an embodiment.

FIG. 10 is a chart illustrating the time cost for Cauchy data while varying N according to an embodiment.

FIG. 11 is a chart illustrating the memory space cost for Cauchy data while varying ε according to an embodiment.

FIG. 12 is a chart illustrating the time cost for Cauchy data while varying ε according to an embodiment.

FIG. 13 is a chart illustrating the memory space cost for XMark data while varying ε according to an embodiment.

FIG. 14 is a chart illustrating the time cost for XMark data while varying ε according to an embodiment.

FIG. 15 is a block diagram that illustrates an example of a computer (computer setup) having capabilities, which may be included in and/or combined with embodiments.

### DETAILED DESCRIPTION

The present disclosure provides a technique to collect data (for a particular entity) from various computers and summarize the data at a server. Various examples are provided below for explanation purposes and not limitation.

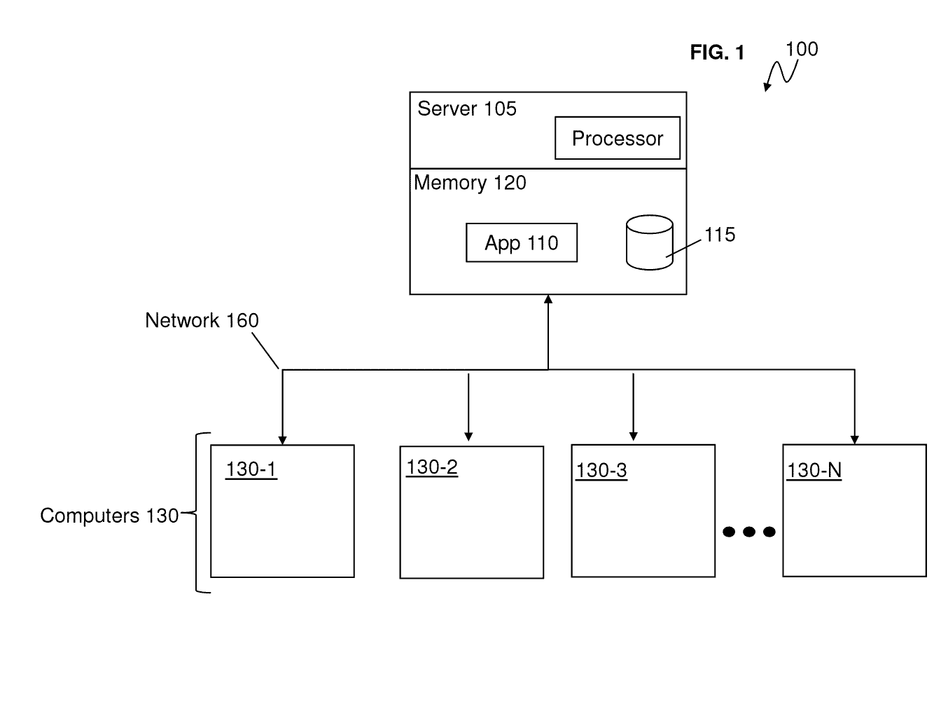

Particularly, an embodiment discloses a software application 110 (shown in in FIG. 1) (e.g., implementing algorithms discussed herein) that quickly creates a small sketch or synopsis of a large dataset I, represented as a list of key-value pairs, for estimating the sum of maximum values, across the set of keys. More formally, for each key κᵢ, the embodiment takes the maximum value νᵢ (e.g., maximum bid) for which (κᵢ, νᵢ) occurs in the stream, and then adds the values νᵢ together across all (other) keys κᵢ (having the respective maximum bid values). The software application may see (i.e., receive) the key-value pairs in an arbitrary (uncontrollable) order (e.g., from various computers), and the goal (of the software application) is to estimate this sum of maximum values (ν) up to a multiplicative factor of 1+ε. Since the order is arbitrary and embodiments are designed to utilize a small amount of memory, the naive solution of storing the maximum value seen so far for each key is too expensive (from a memory perspective). Embodiments provide a method Sketch^{SM} which, for any given parameter ε>0, provides a number which is at least this sum of maximum values and at most 1+ε times this quantity with high probability, using storage which is only 1/ε³ log M words of space, where it is assumed that all values are rational numbers with numerators and denominators being an integer between 1 and M. Moreover, the total amortized time the software applications spends processing the dataset I is linear in the number of key-value pairs (κᵢ, νᵢ).

FIG. 1 is a system 100 for estimating the sum of maximum values across streaming bids via the software application 110 according to an embodiment. A server 105 is connected to one or more computers 130. The computers 130 are computing devices that represent any type of network devices transmitting (i.e., streaming) bids to the server 105. For example, the computers 130 may include devices such as smartphones, cellphones, laptops, desktops, tablet computers, and/or any type of processing device capable of making and communicating bids (for items) to the server 105.

The server 105 may be connected to the various computers 130 through one or more networks 160. The software application 110 may be stored in memory 120. The results and values of processing and execution of algorithms performed by the software application 110 may be stored in a database 115.

The server 105 and computers 130 comprise all of the necessary hardware and software to operate as discussed herein, as understood by one skilled in the art, which includes one or more processors, memory (e.g., hard disks, solid state memory, etc.), busses, input/output devices, computer-executable instructions, etc.

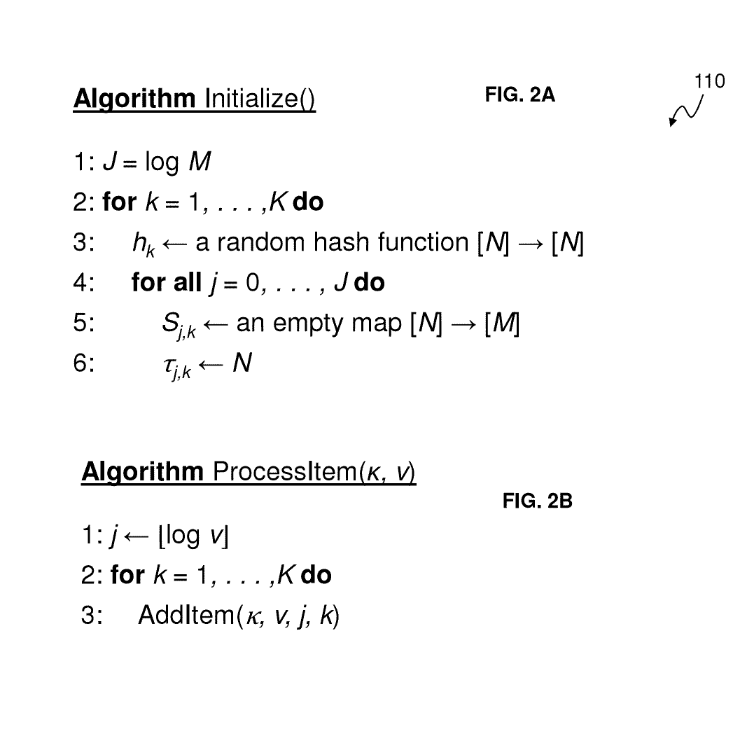

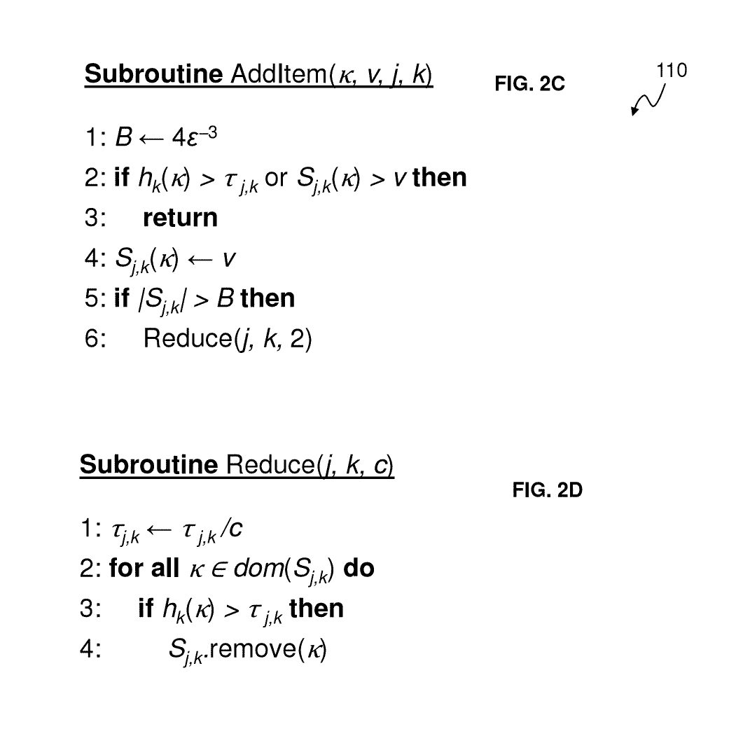

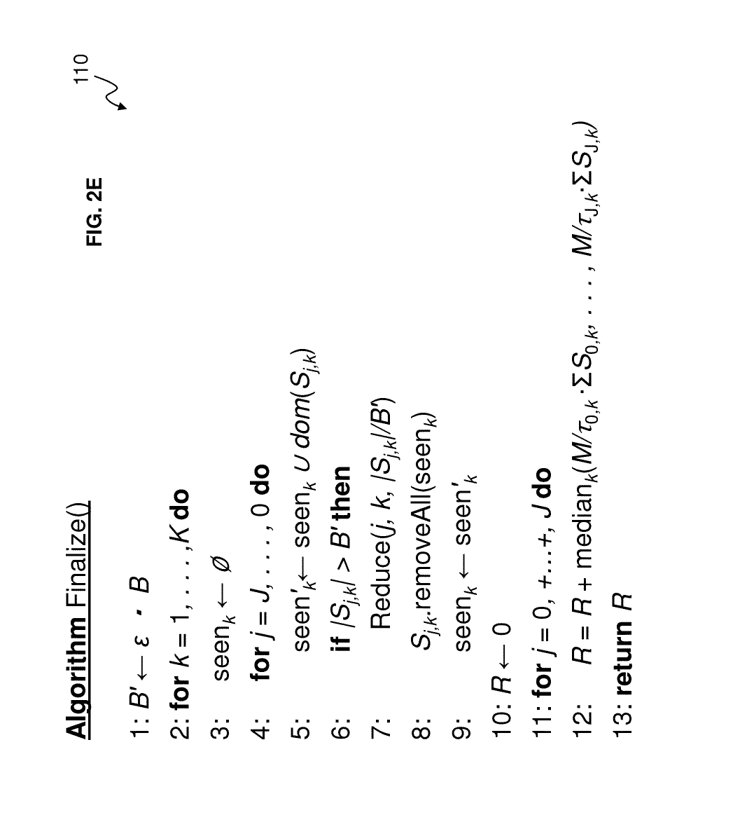

An example scenario is now provided for explanation purposes and not limitation. The scenario (executed by the software application 110) estimates the maximum total sales over streaming bids for an entity such as eBay®. Note that the maximum total sales for bids on items denotes the summation of highest bids for each individual (i.e., the bids are on different items, such as shoes, books, electronic equipment, etc., but the maximum (highest) bid for each item is determined to estimated the maximum total sales summed up for all of the items). The software application 110 may execute a Sketch^{SM} algorithm. The Sketch^{SM} algorithm of the software application 110 is shown as examples in FIGS. 2A, 2B, 2C, 2D, and 2E according to an embodiment. Suppose eBay® has 100 million items for sale. The software application 110 associates these (100 million) items with the numbers 1, 2, 3, 4, . . . , 100 million, each number corresponding to a unique item. The 100 million items are denoted by N. Assume that eBay® would like to estimate the sum of the maximum bids placed for each item, since this equals the total revenue going through eBay® at a given time. Instead of performing this (summation) exactly, the software application 110 of the present disclosure shows how to estimate the sum of maximum bids approximately, up to an epsilon (ε) percent error, where ε is an adjustable parameter. For an example of an (acceptable) error, the error (ε) may be set as 1, 2, 3, 4, 5, 10, 15%, and so forth. Setting c to be small allows for more accuracy in applications that demand it, while setting c to be large allows for a smaller amount of memory. In some applications the data already has underlying noise in it and there is no reason to set ε to be too small.

Suppose all valid bids are between $1 and $256. This would correspond, in the present disclosure, to the parameter M=256. Suppose further for this example, that the parameter c is equal to 10% (i.e., 0.1). Then the total storage (memory) required of this embodiment, in 32-bit words is 4·(1/c³)·log₂ M=4·1000·8=32000. Notice that this is much smaller than 100 million words (of memory space in the server 105), which would be the total number of words needed with the naive approach of, for each item on eBay®, storing the maximum bid seen so far (by the server 105). This may be particularly useful for a third party intermediate vendor hired by eBay® to estimate its total revenue. This third party vendor (which may operate the server 105) does not have the storage resources of eBay®, and so needs to estimate the total revenue using as few words of storage as possible (via the software application 110). Note word is a term for the natural unit of data used by a particular processor design. A word is a fixed sized group of bits that are handled as a unit by the instruction set and/or hardware of the processor. The number of bits in a word (i.e., the word size, word width, or word length) is a characteristic of the specific processor design or computer architecture.

The software application 110 resides on a computer, perhaps the server 105 of eBay®, or the server 105 of the third party vendor, which sees a stream of bids (I) passing through it. Each bid has value (i.e., bid value) and an item (key) that the bid is applied to. The software application 110 builds a sketch Sketch^{SM} of the bids that the server 105 sees (which are the bid requests (i.e., item κ with a bid value ν forming a key-value pair (κ, ν)) that are made to eBay® for the different items). In the present disclosure, B is a parameter in the subroutine which is equal to 4·(1/ε)³=4000. J is equal to the value log M (using base 2), which is log₂ 256, which is 8. For this example, K=2, and N is the total number of items, such that N is equal to 100 million. To obtain the best approximation of the maximum total sales summed over all of the bids, the software application 110 is configured to execute the estimation for the same streaming bids K different (individual times). Then the software application 110 takes the median of the K different estimated maximum total sales to be the answer. In this example, the software application 110 runs the estimate K=2 separate times.

In the initialization subroutine (shown in FIG. 2A), two random functions (hₖ) h₁ and h₂, from the set {1, 2, 3, 4, . . . , 100 million} to the set {1, 2, 3, 4, . . . , 100 million} are chosen. For instance, h₁ (1) might equal 70001, and h₁(2) might equal 399. In general, h₁ is a random mapping between these two sets as understood by one skilled in the art. Similarly, h₂ is also a random mapping between these two sets. One skilled in the art understands a random hash function. For example, a standard block cipher such as AES (Advanced Encryption Standard) may be used. In the initialization phase, the software application 110 also sets: S_{{0, 1}}, S_{{1, 1}}, S_{{2, 1}}, . . . , S_{{8, 1}} to be empty sets and S_{{0, 2}}, S_{{1, 2}}, S_{{2, 2}}, . . . , S_{{0, 1}} to be empty sets. The set is denoted by S_{j,k}.

In the initialization subroutine, the software application 110 also sets (thresholds): τ_{{0, 1}}=τ_{{1, 1}}=τ_{{2, 1}}= . . . =τ_{{8,1}}=100 million and τ_{{0, 2}}=τ_{{1,2}}=τ_{{2,2}}= . . . =τ_{{8,2}}=100 million. The parameter τ_{j,k} is threshold that changes through the estimation process. The parameters τ_{{i, j}} start off large and gradually decreases throughout the course of the algorithm. As they decrease this means that fewer items are retained in each S_{{i, j}}.

Now, consider what happens in the ProcessItem subroutine(κ,ν) shown in FIG. 2B. Suppose there is a bid for a certain book with bid value $50. This book is one of the items on eBay®, and as stated above, this book as an item is therefore associated with a number κ (kappa) in the range {1, 2, 3, . . . , 100 million}. The number κ uniquely identifies this book. Suppose this number is 3; that is, this book is the third item listed on the eBay® website. Then, κ=3, and ν=50 in the input to the ProcessItem subroutine. Accordingly, in the ProcessItem(3, 50) routine, the software application 110 sets j=log₂ ν=log₂ 50=5. Then, for k=1 and for k=2, the software application 110 runs the (AddItem subroutine (κ, ν, j, k) shown in FIG. 2C): AddItem(3, 50, 5, 1) and AddItem(3, 50, 5, 2). Note that j is associated with or equals j=log₂ ν. The j corresponds to a range.

AddItem(3, 50, 5, 1) computes h₁(3), which is a random number between 1 and 100 million. AddItem(3, 50, 5, 1) then checks if h₁(3) is greater than τ_{{5,1}}=100 million, which h₁(3) is not. AddItem has S_{j,k}(κ) which means the bid value of κ (the item) in the set S_{j,k}. AddItem(3, 50, 5, 1) also checks if S_{{5, 1}}(3)>50. Since S_{{5, 1}} has not been updated yet, S_{{5, 1}} is an empty set, and so S_{{5, 1}}(3) is not yet defined. So this condition S_{{5,1}}(3)>50 does not hold. So line 3 of AddItem(3,50,5,1) is skipped. In line 4, S_{{5,1}}(3) is set to equal 50. Now, when S_{{5, 1}} was initialized it had size 0, and now it has size 1, so |S_{{5,1}}|=1. In line 5, it is checked whether the size of |S_{{5,1}}|>B; that is, whether 1>4000. Since it is not, line 6 is skipped. Note that B is a bounded size where B=4ε⁻³. Note that S_{j,k}(κ) is the value at κ, while |S_{{j,k}}| is the size of the amount of key-value pairs (also interchangeably referred to as item-value pairs) in S_{{j,k}}. S_{j,k} is a random sample of all items that land in the range corresponding to j, in the k-th independent execution.

AddItem(3, 50, 5,2) then separately computes h₂(3), which is a random number between 1 and 100 million. AddItem(3, 50, 5,2) then checks if h₂(3) is greater than τ_{{5,2}}=100 million, which it is not. AddItem(3, 50, 5,2) also checks if S_{{5,2}}(3)>50. Since S_{{5,2}} has not been updated yet, S_{{5,2}} is an empty set, and so S_{{5,2}}(3) is not yet defined. So this condition S_{{5,2}}(3)>50 does not hold. So line 3 of AddItem(3,50,5,2) is skipped. In line 4, S_{{5,2}}(3) is set to equal 50. Now, when S_{{5,2}} was initialized it had size 0, and now it has size 1, so |S_{—}{5,2}|=1. In line 5, it is checked whether |S_{{5,1}}|>B, that is, whether 1>4000. Since it is not, line 6 is skipped. Note that hₖ comparison is utilized to randomly discard items (i.e., to randomly discard item-value pairs). Also, keeping the size |S_{{5,2}}| below B is utilized to start the Reduce subroutine shown in FIG. 2D (which randomly reduces the size of each individual j-th value range).

More items (κ) and associated bids (ν) are placed in the stream, and ProcessItem is continually run on these items and bids in the manner described in the previous paragraphs. Now, consider how the Reduce subroutine(j, k, c) works which is shown in FIG. 2D. Suppose, after many ProcessItem requests, at some point the software application 110 obtains a ProcessItem(7, 18) request, meaning the 7-th item (κ) held by eBay® was given the bid $18. Here, κ=7 and ν=18. The software application 110 sets j=log₂ ν=4. Then, for k=1 and for k=2 (i.e., two separate estimates are individually run and k indicates which estimate is running), software application 110 runs: AddItem(7, 18, 4, 1) and AddItem(7, 18, 4, 2).

AddItem(7, 18, 4, 1) computes h₁(7), which is a random number between 1 and 100 million. AddItem(7, 18, 4, 1) then checks if h₁(7) is greater than τ_{{4,1}}=100 million, which it is not. AddItem(7, 18, 4, 1) also checks if S_{{4, 1}}(7)>18. Let's suppose for this example that it is not. So line 3 of AddItem(7, 18, 4, 1) is skipped. In line 4, S_{{4,1}}(7) is set to equal 18. Now, suppose for this example that |S_{{4,1}} has size 4001 in line 5 of AddItem(7, 18, 4, 1). Then, |S_{{4,1}|}>B since 4001>4000. In this case, line 6 of AddItem(7, 18, 4, 1) is executed, that is, the subroutine Reduce(4, 1, 2) is executed.

To see how Reduce (4, 1, 2) works, in the first line τ_{{4,1}} is 100 million. In Reduce(j, k, c), τ_{j,k} is now set to τ_{j,k}/c. As such, τ_{{4,1}} is then replaced with τ_{{4,1}}/2=50 million, since c=2. Note that c is a constant, and that τ_{j,k} means the threshold for j-th value range. Now consider line 2. S_{{4,1}} is a set of size 4001 item-bid pairs. For each item κ for which there is an item-bid pair (κ, ν) in the set S_{{4,1}}, the software application 110 executes line 3 of Reduce(4,1,2). That is, suppose the item-bid pair (99, 10) occurs in the set S_{{4,1}}. Then in line 3 of Reduce(4,1,2) the software application 110 computes h₁(99), which is a random number between 1 and 100 million. The software application 110 then performs the check: is h₁(99)>50 million? If this is true, then in line 4 of Reduce(4,1,2) the software application 110 removes the item-bid pair (99,10) from the set S_{{4,1}}. If h₁(99) is not larger than 50 million, then the software application 110 skips line 4 of Reduce(4,1,2).

Now, consider how the algorithm Finalize( ) works shown in FIG. 2E, which provides the overall estimate of the sum of maximum bid values for all of the items. In line 1 of Finalize( ), B′ is equal to ε·B=0.1·4000=400. Note that B′ is a more narrow bounded size. Then lines 2-9 of Finalize( ) are run for k=1 and for k=2. Now, note that the case k=1, and the case k=2 are analogous. In line 3, the software application 110 initializes the set seen₁ to be the empty set (). Then in line 4, for each value j from 8 to 0, the software application 110 executes lines 5 through 9. Consider the first value, j=8, for which lines 5 through 9 are executed in Finalize( ). In line 5 the software application 110 defines the set seen′₁ to be the union (∪) of the items in seen₁ and the items for which there is an item-bid pair in S_{{8,1}}. In line 6, there is a check whether the size |S_{{8,1}}| of S_{{0, 1}} is larger than 400 (which is B′). If this is true, the software application 110 runs Reduce(8, 1, |S_{{0, 1}}|/400), which has the effect of reducing the size of S_{{8,1}} to 400. In line 8 of Finalize( ), the software application 110 removes all items for which there is an item-bid pair in S_{{0, 1}} for which the item is in seen₁. In line 3, seen₁ was set to empty, so this has no effect at the moment. However, in line 9, seen₁ is set to equal seen′₁, which is the set of items in S_{{}8,1}. Then, the software application 110 returns to line 4, and runs lines 5 through 9 with the value j=7. The software application 110 then repeats the above steps. When the software application 110 repeats these steps for j=7, line 8 might now have an effect, since the software application 110 removes all items for which there is an item-bid pair in S_{{7,1}} for which the item is in seen₁. In line 9 of the previous iteration (i.e., j=8), seen₁ was set to S_{{8,1}}, so the software application 110 may remove items from S_{{7,1}}. Note that j=8 (in S_{j,k}) is the highest value range for an item, so if that same item is seen in a lower j-th range, lines 3-9 remove the duplicative bid value from any of the lower ranges. The same analogously applies when an item is in j=7 value range all the way to j=1 value range; the item is not removed from the lowest j-th value range (j=0), because there is no lower value range that could possible have lower bid than the j=0 value range.

Finally, it is time to move on to lines 10-13 of Finalize( ). In line 10, a parameter R is set to be equal to 0. In lines 11-12, for each j=0, . . . , 8, and k=1, 2, let b_{{j,k}} be equal to the number (M/τ_{j,k})·ΣS_{j,k} (which is (M/τ_{j,k}) times the sum of all maximum bids of items in S_{{j,k}}). The software application 110 goes back and finds the original bid for each item that caused the respective items to be placed in their respective j-th values ranges. The software application adds up each of the real bids values for each maximum bid in each j-th range, and then adds up the sums from all of the j-th ranges. Note that (M/τ_{j,k}) is the scale factor to account for all of the items randomly discarded throughout estimation process. Here the scale factor (M/τ_{j,k}) may be different for each range j, since the τ_{j,k}, while starting off the same, varies for the different j through the course of the algorithm. Here M=256, and τ_{{0, 1}} is updated throughout the course of the stream in the Reduce ( ) subroutine. For example, throughout the course of the algorithm τ_{{j,k}} changes by a factor 2 whenever reduce is invoked. Then, the output is a₀+a₁+a_{—}2+ . . . +a_{{log M}}=a₀+a₁+a₂+ . . . a₈, where aⱼ, for j=0, 1, 2, . . . , 8, is equal to (b_{{j,1}}+b_{{j,2}})/2, that is, the median value of b_{{j,1}} and b_{{j,2}} (which in this case user can set to be the average value of b_{{j,1}} and b_{{j,2}}). When more than two ks are run for the estimate, the software application 110 arranges the maximum total sales from each in order (e.g., from least to greatest) and takes the median value as the answer.

The method was validated experimentally on several different kinds of data sets, such as key-value pairs drawn from a uniform distribution, a Cauchy distribution, and data obtained by the XMark auction data generator (e.g., from the application below to auctions), which shows a dramatic reduction in the storage (as discussed further below). Interestingly, the time to process the data set is reduced. There may be a time complexity reduction that arises because the algorithm (of the software application 110) lends itself to significantly better CPU cache utilization.

As discussed above, the main example application (but not only) is utilized in closed advertisement auctions. In this setting users make bids on items held by an auction provider. Here, the key in the key-value pairs is a user and an item (e.g., κ), while the value is the bid (ν) made by that user on that item.

This method is designed for massive-scale user interaction on bids, such as performed by eBay® or other auctioneers (as discussed above). In this model the auction provider's data resides on multiple servers and communication among the servers is considered costly. As can be seen, the method of the present disclosure enables the auction provider to cheaply and quickly obtain an estimate to the sum of maximum bid values over all items, which can give an guaranteed approximation to the total revenue flow, at a fraction of the cost (communication, computationwise (i.e., time), and memory) that it would take to compute this value exactly. This can be also done by a third party intermediate vendor hired by the auction provider, which just sees the stream of bids on items and produces a sketch, which can be used to obtain a good approximation, and sends this sketch to the auction provider. The vendor can be limited in computational resources and storage capabilities, yet still provide almost as good an answer to the business volume to the ad auctioneer, namely, the exact sum of maximum bid values.

Other uses for the embodiment include aggregation sensor signals. In this setting, there are multiple sensors which receive signals from the same point, and are intended to handle noise or disruptions. For example, a sensor's signal may be blocked due to an obstacle, but by returning the maximum value across sensors, embodiments reduce the risk of underestimating. Many objects may be monitored, and the software application 110 is configured to sum or average maximum signal value across these objects. Still other examples include network traffic monitoring, where the software application 110 is concerned about the average maximum load on the routers in the network. This can be used as a pessimistic estimator for the total load on the network.

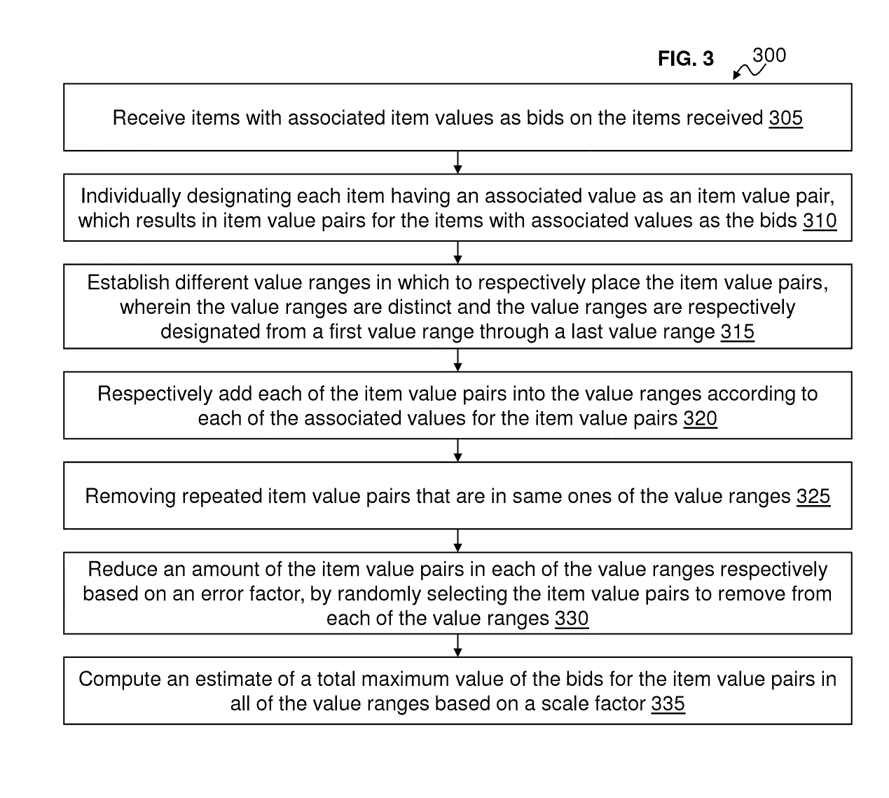

FIG. 3 is a method 300 for computing an estimation of maximum total sales over streaming items (i.e., maximum bids) by the software application 110 according to an embodiment. Reference can be made to FIGS. 1 and 2.

The software application 110 is configured to receive items (e.g., κ) with their associated item values (ν) as bids on the items received at block 305.

The software application 110 is configured to individually designate each item having is associated bid value as an item value pair (κ, ν), which results in item value pairs for the each of items with their respective associated values as the bids at block 310. Each bid on an item has its own bid value ν.

At block 315, the software application 110 is configured to establish different value ranges (j=0, . . . , J) in which to respectively place the item value pairs, where the value ranges are distinct and the value ranges are respectively designated from a first value range through a last value range, where the first value range is a lowest value range(j=0), the last value range is a highest value range (j=J), and other value ranges are in between the first value range and the last value range.

The software application 110 is configured to perform the following process/iteration. The software application 110 is configured to respectively add each of the item value pairs into the value ranges according to each of the individual associated values for the item value pairs at block 320.

The software application 110 is configured to remove repeated item value pairs (i.e., associated the same item (κ)) that are in same ones of the value ranges at block 325. When there is a repeated item (κ) in the same j-th range, the software application 110 determines the item (κ) with the highest bid value (ν) and stores the item value pair in that j-th value range (as by S_{j,k}(κ)>ν and S_{j,k}(κ)←v in lines 2-4 of AddItem of FIG. 2C).

The software application 110 is configured to reduce an amount (i.e., size or number) of the item value pairs in each of the value ranges respectively based on an error factor (i.e., κ), by randomly selecting the item value pairs to remove from each of the value ranges at block 330. This is done via |S_{j,k}|>B in AddItem( ) and/or again via |S_{j,k}|>B′ with Reduce(j, k, |S_{j,k}|/B′).

The software application 110 is configured to compute an estimate of a total maximum value (R) of the bids for the item value pairs in all of the value ranges based on a summation of all the value ranges and a scale factor (M/τ_{j,k}) at block 335. For example, the estimation of the total maximum value of the bids is shown in lines 10-13 in Finalize( ) in FIG. 2E.

Additionally, the process/iteration further includes determining when identical items are in different ones of the value ranges, and removing the identical items from lower ones of the value ranges, which results in the items, corresponding to the item value pairs, only being in a highest possible value range for the associated values and results in duplicative items not being in any of the value ranges. An example is shown in lines 3-9 of Finalize( ).

The software application 110 is configured to compute the estimate of the total maximum value of the bids for the item value pairs in all of the value ranges based on the scale factor which includes: adding the associated values of all the bids in the value ranges for the items to obtain a sum, and multiplying the sum by the scale factor corresponding to the amount/number of item value pairs in each of the value ranges that were randomly removed, where the scale factor (M/τ_{j,k}) increases the sum to account for the amount of item value pairs randomly removed. An example is shown in lines 10-13 of Finalize ( ).

The software application 110 is configured to repeatedly perform the process/iteration a predetermined number of times (e.g., k where k=1, . . . , K and K is selected in advance) to generate a first estimate of the total maximum value (e.g., k) through a last estimate of the total maximum value (K), and to arrange the first estimate of the total maximum value through the last estimate of the total maximum value in order according to numerical values. From the ordered arrangement, the software application 110 is configured to select a median (i.e., the medianₖ) of the numerical values arranged in order as the estimate of the total maximum value of the bids for the total sales.

The software application 110 is configured to respectively add each of the item value pairs into the value ranges according to each of the associated values for the item value pairs comprises a first phase which includes the following: applying a hash function to each particular item in a particular value range to obtain a random hash function number, where the particular item has a particular item value pair; determining when the random hash function number is greater than a threshold, the threshold is a function of a total number of the items; when the random hash function number is greater than the threshold, not adding the particular item value pair to the particular value range which results in the particular item value pair being randomly discarded; when the random hash function number is less than the threshold, adding the particular item value pair to the particular value range; and respectively repeating the first phase for all of the value ranges. Note that the estimation is individually run k number of times to have a total of K copies.

Additionally, the first phase further includes: determining that the amount of the item value pairs in the particular value range is greater than a bounded size (B), the bound size is a function of the error factor; and when the amount of the item value pairs in the particular value range (i.e., the j-th value range) is greater than the bounded size, applying a second phase.

The software application 110 is configured to reduce the amount of the item value pairs in each of the value ranges respectively based on the error factor, by second phase which includes: decreasing the threshold by a predetermined amount; applying the hash function to the particular item in the particular value range to obtain the random hash function number; determining that the random hash function number is greater than the threshold decreased by the predetermined amount; when the hash function number is greater than the threshold decreased by the predetermined amount, removing the particular item value pair for the particular item from the particular value range; and respectively repeating the second phase for all of the items in the particular value range resulting in the amount of the item value pairs in the particular value range being reduced by randomly removing the item value pairs. An example is shown in the Reduce( ) algorithm.

In the section below, mathematical details are discussed below for the algorithm Sketch^{SM} (e.g., executed by the software application 110 in server 105) for approximating τ max(I) over a given stream I. This section also proves the correctness (i.e., approximation guarantee) of the algorithm, analyzes its complexity, and describes an experimental study thereof. Sub-heading or sub-titles are provided below for ease of understanding and not limitation.

The algorithm Sketch^{SM} gets as input a stream I and an error factor ε>0. The algorithm generally operate as follows: Throughout the streaming processing, the algorithm maintains a (random) sketch of a bounded size B, in the spirit of previous algorithms for counting distinct items. Now, the present disclosure denotes log M by J. The sketch consists of J sets S₀, . . . , S_{J} where Sⱼ holds items (κ, ν) with νε[2^{j}, 2^{j+1}−1]. In other words, each S₀, . . . , S_{J} has it own range [2^{j}, 2^{j+1}−1] in which it places items whose ν fits into this particular range (where Sⱼ is the set of all items in the range). Once the stream scanning is done, three operations are applied to each Sⱼ. First, random elements are removed from Sⱼ to reach the smaller bound ε·B. Second, each item (κ, ν) is deleted whenever (κ, ν′)εS_{j′}for some ν′ and j′>j. Note that v′ is the value of the bid with identity κ. Third, an estimation sⱼ is made on the sum of all values that should have ended in Sⱼ had there been no size bound. The estimation of Σmax(I) is then the sum of the sⱼ. Here, (little) sⱼ refers to the size of Sⱼ (number of key-value pairs maintained from the j-th range at a given time in the algorithm). Nevertheless, to accommodate random error, the present disclosure maintains K different copies of the sketch. So, for each j we have S sets S_{j,1}, . . . , S_{j,K} that are maintained independently; in addition, for estimating τ max(I), the present disclosure uses the median of the sⱼ along S_{j,1}, . . . , S_{j,K}. The pseudo code for the algorithm Sketch^{SM} (executed by the software application 110) is depicted as an example in FIGS. 2A, 2B, 2C, 2D, and 2E (generally referred to as FIG. 2), and further detail of the algorithm is provided below.

Data Structures and Initialization: As explained above, the algorithm Sketch^{SM} maintains a set S_{j,k} for all j=0, . . . , J and k=1, . . . , K. The disclosure refers to S_{j,k} as a map, since S_{j,k} stores at most one item (κ, ν) for each key κ (hence, it is a partial function from [N] to [N]). N is the total number of items. Associated with S_{j,k} is a threshold τ_{j,k}ε[N], which is initially equal to N. Finally, for each k=1, . . . , K the algorithm uses a random hash function hₖ over [N] that is randomly selected. Specifically, hₖ is obtained by selecting random integers mₖ and cₖ uniformly from [N], and defining hₖ(x)=mₖx+cₖ. Initialize( ) in FIG. 2A initializes all the S_{j,k}, τ_{j,k}, and hₖ.

Item processing: To process a stream item (κ, ν), the algorithm ProcessItem(κ, ν) of FIG. 2B is applied. This algorithm ProcessItem(κ, ν) applies the subroutine AddItem(κ, ν, j, k) for j=└log ν┘ and for all k=1, . . . , K. This subroutine AddItem(κ, ν, j, k) (in FIG. 2C) does nothing if either hₖ(κ) is greater than τ_{j,k} or if S_{j,k} contains an item (κ, ν′) for some ν′>ν. Otherwise, (κ, ν) is added to S_{j,k} (possibly replacing an existing (κ, ν′) with ν′≦ν). Taking no action for hₖ(κ)>τ_{j,k} means that the particular item κ that has been hashed (to have a random hash number) is discarded and is not added into the j-th value range for this item κ (having a bid value ν). If S_{j,k} already contains an item (κ, ν′), this means that a previous key value pair has been placed in S_{j,k} for the item κ; when the new (same) item κ has a bid value ν, the two bid values for the old and new bids of the particular item κ are compared. When (old) ν′>ν (new), the new is not added (i.e., discarded) into the same j-th range with the higher ν′. However, if v is greater than ν′, the old value of ν′ is replace with the new value of ν for the item κ.

The subroutine AddItem(κ, ν, j, k) bounds the size of the S_{j,k}, as follows. If |S_{j,k}|>B after adding (κ, ν), where B=4/ε³, then the subroutine Reduce(j, k, c) is called with c=2. This subroutine operates as follows. First, τ_{j,k} is decreased by the multiplicative factor c. Then, every item (κ′, ν′)εS_{j,k} is deleted if hₖ(κ′)>τ_{j,k} (where now the new τ_{j,k} is used). Note that in the pseudo code, dom(S_{j,k}) denotes the set of all the keys κ′ in the items of S_{j,k}. That is, of all the (key, value) pairs in S_{j,k}, dom(S_{j,k}) indicates the set of keys. The subroutine Reduce(j, k, c) in FIG. 2D is also called during reconstruction, as is explained next.

Reconstruction: In the end of scanning the stream I and processing its items, the algorithm finalizes by reconstructing the estimate R of τmax(I). This is done by the algorithm Finalize( ) of FIG. 2E. Two main phases are applied by this algorithm Finalize( ). In the first phase, lines 1-9, the algorithm reduces the size of each S_{j,k} to B′=ε·B by calling Reduce(j, k, c) with c=|S_{j,k}|/B′, if indeed S_{j,k} has more than B′ elements. In addition, after the reduction, the algorithm deletes from S_{j,k} every item (κ, ν) such that κ appeared (as a key) in S_{j′,k}, for some j′>j, before reduction was applied to S_{j′,k}. Note that the set seen′ₖ in the pseudo code is used for storing the original items in S_{j′,k} for j′>j. The second phase, lines 10-13, computes the estimate R and returns the estimate R. For each j=0, . . . , J and k=1, . . . K, let b_{j,k} be the number (M/τ_{j,k})·ΣS_{j,k}, where ΣS_{j,k} is the sum of all the values in the items of S_{j,k}. The returned estimate R is the sum a₀+ . . . +a_{log M}, where aⱼ is the median value among b_{j,0}, . . . , b_{j,K}.

### Experimental Example

Next, an experimental study is discussed below that was conducted for the algorithm Sketch^{SM} (of the software application 110) according to embodiment. The experimental study is discussed for explanation purposes and not limitation. Specifically, the experimental study empirically investigated the actual approximation ratio of the produced estimation of max^{lub}(I), the space cost, and execution time, compared to the naive approach of storing the maximal value seen for each key (which is discussed next in further detail). Note that lub stands for least upper bound.

Example Setup:

The experiments were run on a Linux™ SUSE (64-bit) server with four Intel® Xeon (2.13 GHz) processors, each having four cores, and 48 GB of memory. The algorithms were implemented in Java™ 1.6 and ran with 12 GB of allocated memory. Each implementation used a single Java™ thread (hence ran on a single core).

Two streaming algorithms were implemented. The first one, Sketch^{SM}, is described above. The second, which is denoted by TreeMap, is a straightforward application of the Java 1.6 java.util.TreeMap object. Each of the two algorithms implemented an interface of three methods: void Initialize(ε), void ProcessItem(κ, v), and double Finalize( ).

In Sketch^{SM}, the three methods execute their correspondents in FIG. 2. In TreeMap, the method Initialize(ε) is empty; ProcessItem(κ, ν) inserts to the tree map the mapping κ→ν if either κ is not in the current set of keys or if κ is mapped to a value smaller than ν; Finalize( ) sums up the values in the tree map and returns the result.

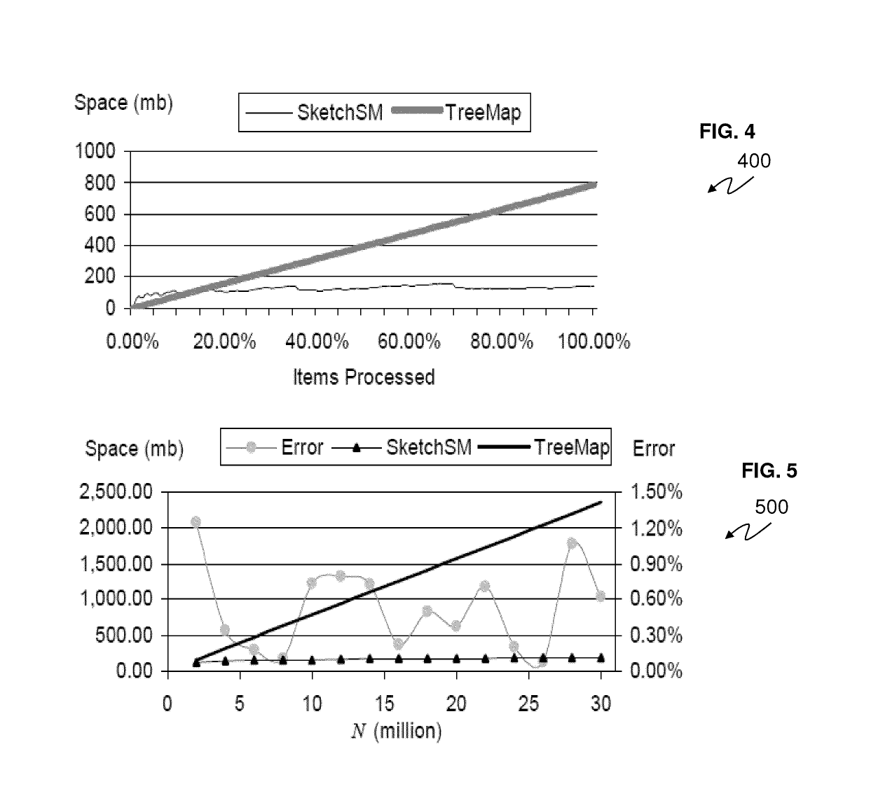

Below, the content of the dataset streams used is discussed. Each such a stream was stored in a file of rows where each row has a pair (κ, ν) with both κ and ν being integers. To execute each one of the two algorithms, the experiment first called Initialize(ε), then sequentially read the rows (κ, ν) in the stream file, calling ProcessItem(κ, ν) on each, and terminated with Finalize( ). To investigate the space usage, there was a recording of the difference between the total size and the available size of the Java heap as recorded in each check point, where a check point took place every 1/100-fraction of the processed data. FIG. 4 is a chart 400 illustrating space usage recordings throughout the execution of the two algorithms (on the same input). The x-axis shows the percentage of items processed and the y-axis shows the memory space utilized in megabytes (mb). As can be seen the Sketch^{SM} algorithm utilizes less memory space (mb) to estimate the total maximum value for all the items (κ).

Notation:

Consider that a stream instance was experimented upon. The experiment consistently uses N to denote the number of key values in the stream; note that this number is smaller than the total number of items in the stream. An execution of Sketch^{SM} is parameterized by ε, and the resulting output value is associated with an error value, which is defined to be:

$$error = max \{ \frac{{S}^{*}}{S} - 1 , \frac{S}{{S}^{*}} - 1 \}$$

where S is the real sum (i.e., the output value of TreeMap) and S* is the output value of Sketch^{SM}.

Experiments on Random Streams:

In this part of the experimental study, synthetic random streams were generated by two different methods. For reasons that are clarified later, the first method is denoted by uniform and the second by Cauchy. To generate random data, the experimental study utilized the I/O libraries provided by the online textbook Introduction to Programming in Java at Princeton University.

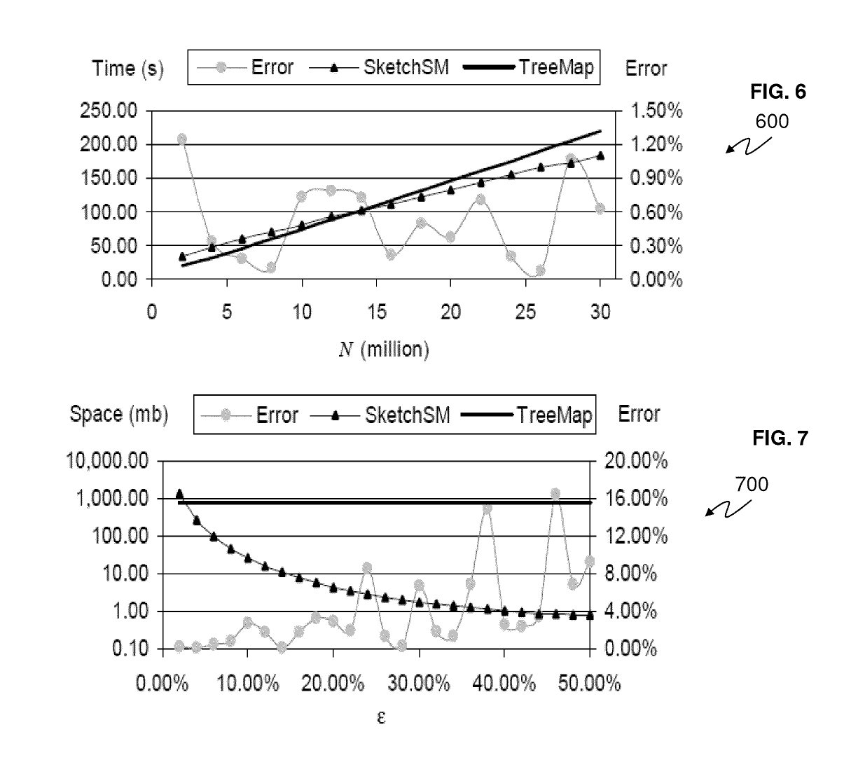

In the uniform method, the experiment generated exactly 3 items (κ, ν) for each key κ, where in each the value ν is randomly chosen from the uniform distribution between 2 and 1000. The experiment fixed ε=0.05 and varied N. The charts 500 and 600 in FIGS. 5 and 6 show the maximal space usage and the total running time (including initialization and finalization), respectively, of Sketch^{SM} and TreeMap. FIG. 5 shows the memory space cost for uniform values and varying N. Chart 500 has N (in million) on the x-axis, memory space (mb) on the left vertical axis, and error in percent (%) on the right vertical axis. FIG. 6 shows the time cost for uniform values and varying N. Chart 600 has N (in million) on the x-axis, time in seconds (s) the left vertical axis, and error in percent on the right vertical axis

The charts 500 and 600 include also the error of Sketch^{SM} in each execution. As can be seen, the space usage of Sketch^{SM} hardly changes with N while, as expected, that of TreeMap is linear on N. For the case where N=30 million, Sketch^{SM} uses less than 1/15 of the space TreeMap is using. In terms of the execution time, TreeMap is slightly faster up to 10 million; thereafter, Sketch^{SM} becomes faster, and its lead increases with N (due to the effect of the size of the data structures on the insertion time). The error is usually smaller than 0.5% (i.e., one tenth of ε), and the maximal recorded error is 1.18% (for 26 million).

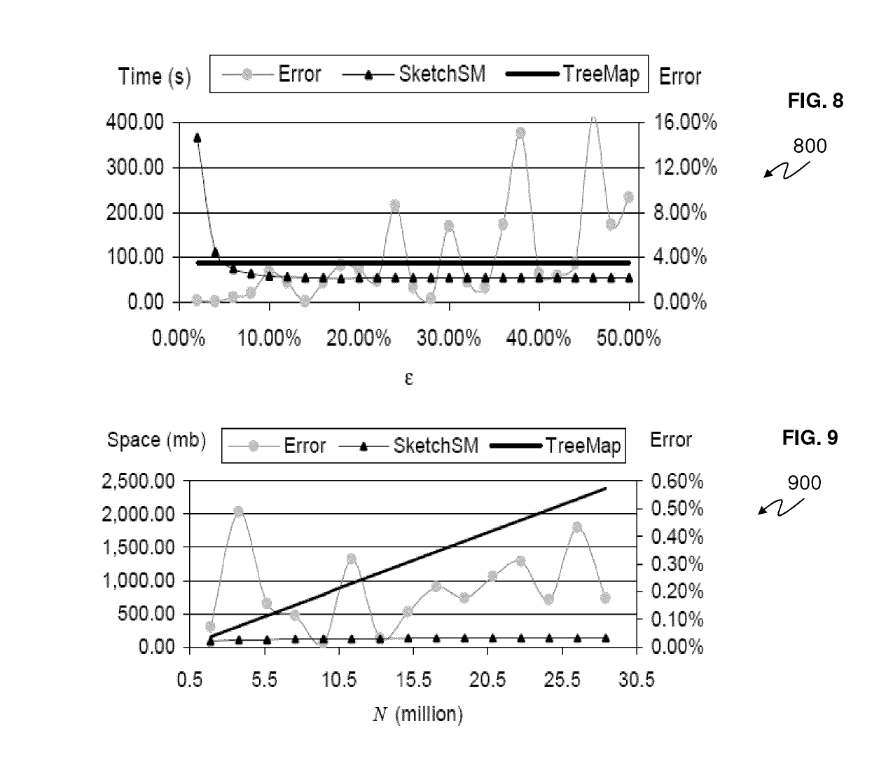

In the next set of experiments, the experimental study fixed N to be 10 million, and varied ε from 2% to 50%. The results (space and time, respectively) are shown in FIGS. 7 and 8. Chart 700 shows ε (epsilon) on the x-axis, memory space (mb) on the left vertical axis, and error in percent on the right vertical axis. Chart 800 shows ε on the x-axis, time (s) on the left vertical axis, and error in percent on the right vertical axis. Observe the dramatic decrease in space usage as ε increases. Interestingly, up to ε=22% the observed error is smaller than 2%, even though at that point the reduction in space is by a factor larger than 250.

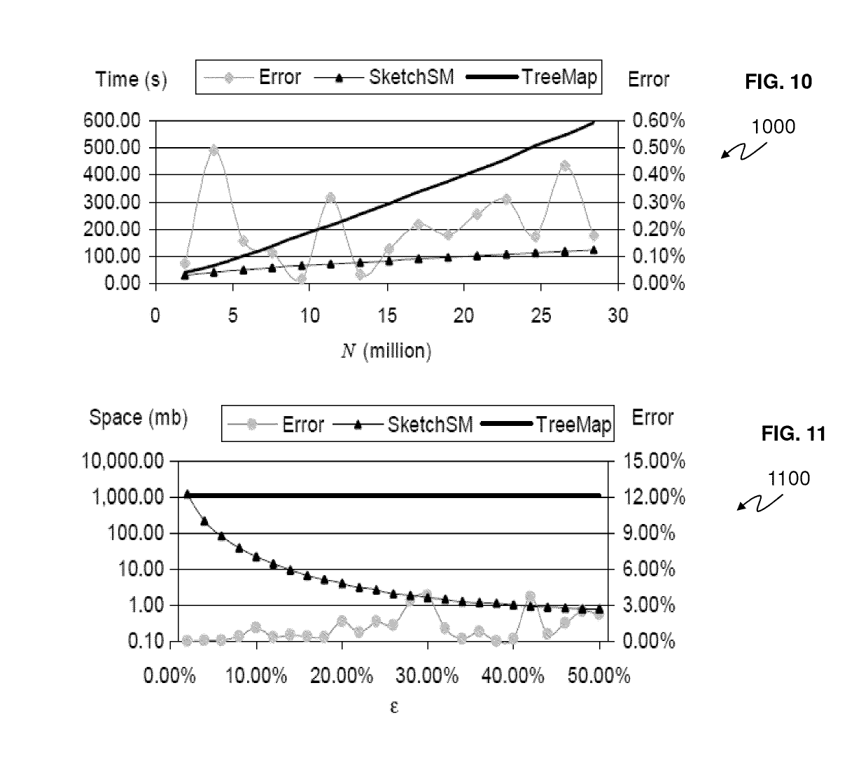

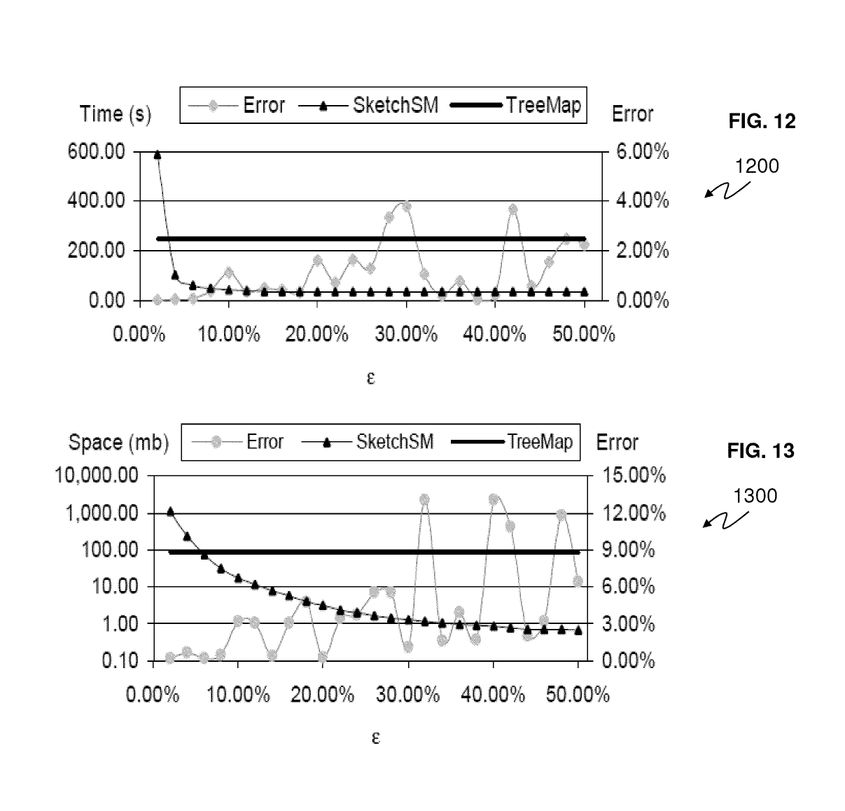

Now, the experiments are described over streams generated by the Cauchy method. To generate a stream instance, the operator chose a number M (which varies in the first set of experiments), and independently generated M entries (κ, v) in the following manner. The key κ is chosen randomly from the uniform distribution over {1, . . . , M}, and ν is obtained by rounding a value chosen from the standard Cauchy distribution. Note that in contrast to the uniform method, the experiment now has no control over the number of values per key, and moreover, the values are taken from a distribution (namely Cauchy) that lacks finite mean and variance. FIGS. 9 and 10 show the space usage of Sketch^{SM} and TreeMap as well as the error of Sketch^{SM}, for varying N. FIG. 9 shows the space cost for Cauchy data while varying N, and FIG. 10 shows the time cost for Cauchy data while varying N. The chart 900 has N (millions) on the x-axis, memory space (mb) on the left vertical axis, and error (%) on the right vertical axis. The chart 1000 has N (millions) on the x-axis, time (s) on the left vertical axis, and error (%) on the right vertical axis. Recall that N is the number of distinct keys (κ) in the stream, and N is smaller than M (for example, from M=17 million but the algorithm determined about 11 million distinct keys). FIGS. 11 and 12 show the results for varying ε. FIG. 11 shows the space cost for Cauchy data while varying ε, and FIG. 12 shows the time cost for Cauchy data while varying ε. Chart 1100 has ε on the x-axis, memory space (mb) on the left vertical axis, and error (%) on the right vertical axis. Chart 1200 has E on the x-axis, time (s) on the left vertical axis, and error (%) on the right vertical axis. In general, all the results are very similar to their correspondents in the uniform method (previously described), except that now the time improvement of Sketch^{SM} over TreeMap is significantly higher. One explanation of this difference is that in the uniform method, entries that share the same key form a consecutive chunk of the stream, and hence, the CPU cache is more frequently hit.

Experiments on XMark Auction Data:

XMark is an XML benchmark project, which includes a generator of XML documents modeling an auction Web site (as understood by one skilled in the art). In this part of the experiments, the operator utilized the XML generator of XMark to generate auction data. Specifically, the operator produced a 2 gigabyte XML document and extracted from it entries of the form (κ, ν) where κ is an auction identifier and ν is a bid (i.e., a monetary (dollar) value). However, the XMark auction model is an open one (where the bidders interactively increase the known maximal bid) while the operator views sum^{lub} as a measure that is more relevant to a closed model (where each bidder privately bids). Therefore, to model a closed auction the operators used, for each auction and bidder, only the maximal bid made by that bidder in the auction. The total number of entries the operator received in the resulting stream instance is 5989594, and the total number of auctions (keys in Sketch^{SM} case) is 1083775.

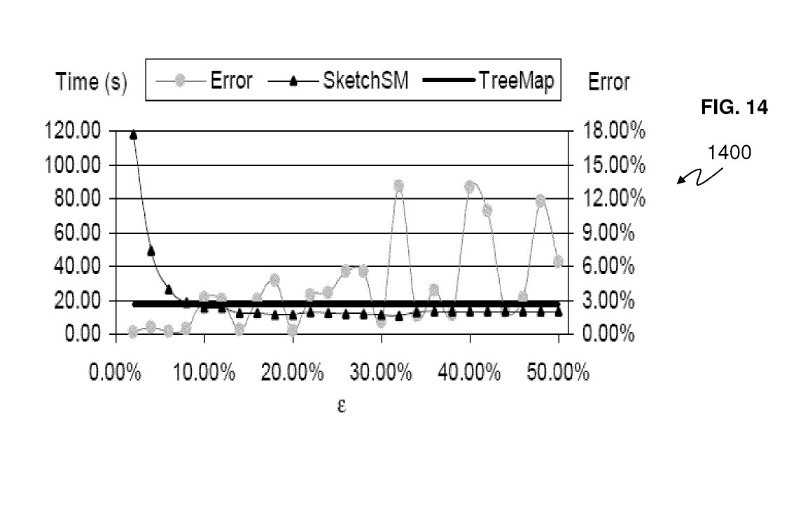

FIGS. 13 and 14 show the space usage and total time, respectively, of Sketch^{SM} and TreeMap. FIG. 13 shows the space cost for XMark data while varying ε, and FIG. 14 shows the time cost for XMark data while varying ε. Chart 1300 has ε (in %) on the x-axis, memory space (mb) on the left vertical axis, and error (%) on the right vertical axis. Chart 1400 has ε (in %) on the x-axis, time (s) on the left vertical axis, and error (%) on the right vertical axis. Particularly, they also show the error of Sketch^{SM}, for varying ε. The results are very similar to those on the data generated by the uniform method, except that now the error tends to be higher. Still, this error is significantly lower than ε; specifically, for ε smaller or equal to 8% the maximal observed error is 1.22%.

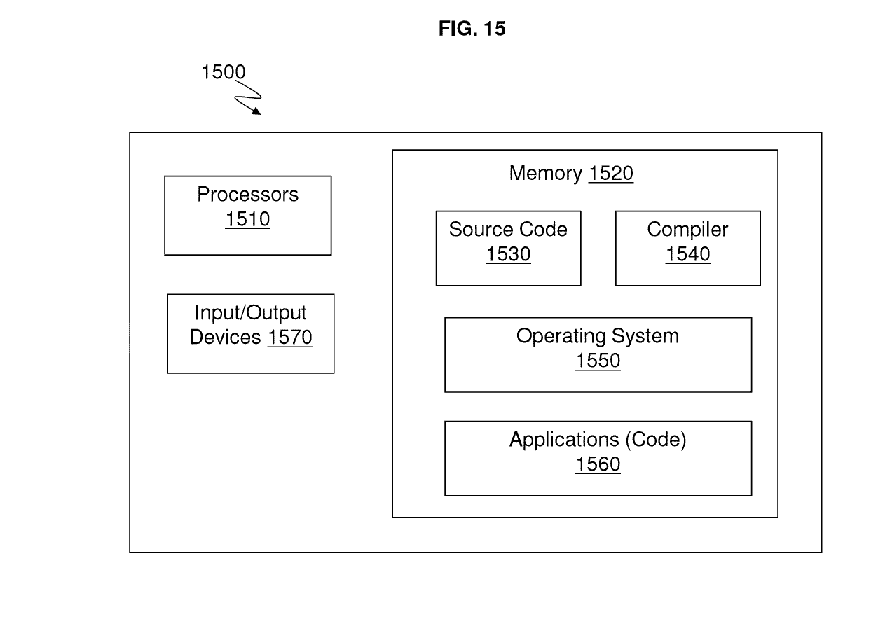

Now turning to FIG. 15, an example illustrates a computer 1500 (e.g., any type of computer system discussed herein including server 105 and computer systems 130) that may implement features discussed herein. The computer 1500 may be a distributed computer system over more than one computer. Various methods, procedures, modules, flow diagrams, tools, applications, circuits, elements, and techniques discussed herein may also incorporate and/or utilize the capabilities of the computer 1500. Indeed, capabilities of the computer 1500 may be utilized to implement features of exemplary embodiments discussed herein.

Generally, in terms of hardware architecture, the computer 1500 may include one or more processors 1510, computer readable storage memory 1520, and one or more input and/or output (I/O) devices 1570 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 1510 is a hardware device for executing software that can be stored in the memory 1520. The processor 1510 can be virtually any custom made or commercially available processor, a central processing unit (CPU), a data signal processor (DSP), or an auxiliary processor among several processors associated with the computer 1500, and the processor 1510 may be a semiconductor based microprocessor (in the form of a microchip) or a macroprocessor.

The computer readable memory 1520 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 1520 may incorporate electronic, magnetic, optical, and/or other types of storage media. Note that the memory 1520 can have a distributed architecture, where various components are situated remote from one another, but can be accessed by the processor(s) 1510.

The software in the computer readable memory 1520 may include one or more separate programs, each of which comprises an ordered listing of executable instructions for implementing logical functions. The software in the memory 1520 includes a suitable operating system (O/S) 1550, compiler 1540, source code 1530, and one or more applications 1560 of the exemplary embodiments. As illustrated, the application 1560 comprises numerous functional components for implementing the features, processes, methods, functions, and operations of the exemplary embodiments.

The operating system 1550 may control the execution of other computer programs, and provides scheduling, input-output control, file and data management, memory management, and communication control and related services.

The application 1560 may be a source program, executable program (object code), script, or any other entity comprising a set of instructions to be performed. When a source program, then the program is usually translated via a compiler (such as the compiler 1540), assembler, interpreter, or the like, which may or may not be included within the memory 1520, so as to operate properly in connection with the O/S 1550. Furthermore, the application 1560 can be written as (a) an object oriented programming language, which has classes of data and methods, or (b) a procedure programming language, which has routines, subroutines, and/or functions.

The I/O devices 1570 may include input devices (or peripherals) such as, for example but not limited to, a mouse, keyboard, scanner, microphone, camera, etc. Furthermore, the I/O devices 1570 may also include output devices (or peripherals), for example but not limited to, a printer, display, etc. Finally, the I/O devices 1570 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 1570 also include components for communicating over various networks, such as the Internet or an intranet. The I/O devices 1570 may be connected to and/or communicate with the processor 1510 utilizing Bluetooth connections and cables (via, e.g., Universal Serial Bus (USB) ports, serial ports, parallel ports, FireWire, HDMI (High-Definition Multimedia Interface), etc.).

In exemplary embodiments, where the application 1560 is implemented in hardware, the application 1560 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

1. A method of computing an estimation of maximum total sales over streaming items, comprising:
receiving items with associated item values as bids on the items received;
individually designating each item having an associated value as an item value pair;
establishing value ranges to place item value pairs, wherein the value ranges are distinct and the value ranges are respectively designated from a first value range through a last value range, where the first value range is a lowest value range, the last value range is a highest value range, and other value ranges are in between the first value range and the last value range;
performing an iteration comprising:
respectively adding each of the item value pairs into the value ranges according to each of the associated values for the item value pairs;
removing repeated item value pairs associated with a same item that are in same ones of the value ranges;
randomly selecting a number of the item value pairs to remove from each of the value ranges, the number based on an error factor;
computing an estimate of a total maximum value of the bids for the item value pairs in all of the value ranges based on summation of all the value ranges and a scale factor.

2. The method of claim 1, wherein the iteration further comprises determining when identical items are in different ones of the value ranges;
removing the identical items from lower ones of the value ranges, which results in the items, corresponding to the item value pairs, only being in a highest possible value range for the associated values and results in duplicative items not being in any of the value ranges.

3. The method of claim 2, further comprising repeatedly performing the iteration a predetermined number of times to generate a first estimate of the total maximum value through a last estimate of the total maximum value; and
arranging the first estimate of the total maximum value through the last estimate of the total maximum value in order according to numerical values.

4. The method of claim 3, further comprising selecting a median of the numerical values arranged in order as the estimate of the total maximum value of the bids for the total sales.

5. The method of claim 1, wherein respectively adding each of the item value pairs into the value ranges according to each of the associated values for the item value pairs comprises a first phase which includes:
applying a hash function to each particular item in a particular value range to obtain a random hash function number, the particular item has a particular item value pair;
determining when the random hash function number is greater than a threshold, the threshold is a function of a total number of the items;
when the random hash function number is greater than the threshold, not adding the particular item value pair to the particular value range which results in the particular item value pair being randomly discarded;
when the random hash function number is less than the threshold, adding the particular item value pair to the particular value range; and
respectively repeating the first phase for all of the value ranges.

6. The method of claim 5, wherein the first phase further comprises:
determining that the number of the item value pairs in the particular value range is greater than a bound size, the bound size is a function of the error factor; and
when the number of the item value pairs in the particular value range is greater than the bound size, applying a second phase.

7. The method of claim 6, wherein reducing the number of the item value pairs in each of the value ranges respectively based on the error factor, by randomly selecting the item value pairs to remove from each of the value ranges comprises the second phase which includes:
decreasing the threshold by a predetermined amount;
applying the hash function to the particular item in the particular value range to obtain the random hash function number;
determining that the random hash function number is greater than the threshold decreased by the predetermined amount;
when the random hash function number is greater than the threshold decreased by the predetermined amount, removing the particular item value pair for the particular item from the particular value range; and
respectively repeating the second phase for all of the items in the particular value range resulting in the number of the item value pairs in the particular value range being reduced by randomly removing the item value pairs.

8. The method of claim 1, wherein computing the estimate of the total maximum value of the bids for the item value pairs in all of the value ranges based on the scale factor comprises:
adding the associated values of all the bids in the value ranges for the items to obtain a sum; and
multiplying the sum by the scale factor corresponding to the number of the item value pairs in each of the value ranges that were randomly removed, the scale factor increasing the sum to account for the number of the item value pairs randomly removed.

9. A computer program product for computing an estimation of maximum total sales over streaming items, the computer program product comprising a computer readable storage medium having program code embodied therewith, the program code executable by a computer to:
receive items with associated item values as bids on the items received;
individually designate each item having an associated value as an item value pair;
establish value ranges to place item value pairs, wherein the value ranges are distinct and the value ranges are respectively designated from a first value range through a last value range, where the first value range is a lowest value range, the last value range is a highest value range, and other value ranges are in between the first value range and the last value range; and
perform an iteration comprising:
respectively adding each of the item value pairs into the value ranges according to each of the associated values for the item value pairs;
removing repeated item value pairs that are in same ones of the value ranges;
randomly selecting a number of the item value pairs to remove from each of the value ranges, the number based on an error factor;
computing an estimate of a total maximum value of the bids for the item value pairs in all of the value ranges based on summation of all the value ranges and a scale factor.

10. The computer program product of claim 9, wherein the iteration further comprises determining when identical items are in different ones of the value ranges;
removing the identical items from lower ones of the value ranges, which results in the items, corresponding to the item value pairs, only being in a highest possible value range for the associated values and results in duplicative items not being in any of the value ranges.

11. The computer program product of claim 10, further comprising repeatedly performing the iteration a predetermined number of times to generate a first estimate of the total maximum value through a last estimate of the total maximum value; and
arranging the first estimate of the total maximum value through the last estimate of the total maximum value in order according to numerical values.

12. The computer program product of claim 11, further comprising selecting a median of the numerical values arranged in order as the estimate of the total maximum value of the bids for the total sales.

13. The computer program product of claim 9, wherein respectively adding each of the item value pairs into the value ranges according to each of the associated values for the item value pairs comprises a first phase which includes:
applying a hash function to each particular item in a particular value range to obtain a random hash function number, the particular item has a particular item value pair;
determining when the random hash function number is greater than a threshold, the threshold is a function of a total number of the items;
when the random hash function number is greater than the threshold, not adding the particular item value pair to the particular value range which results in the particular item value pair being randomly discarded;
when the random hash function number is less than the threshold, adding the particular item value pair to the particular value range; and
respectively repeating the first phase for all of the value ranges.

14. The computer program product of claim 13, wherein the first phase further comprises:
determining that the number of the item value pairs in the particular value range is greater than a bound size, the bound size is a function of the error factor; and
when the number of the item value pairs in the particular value range is greater than the bound size, applying a second phase.

15. The computer program product of claim 14, wherein reducing the number of the item value pairs in each of the value ranges respectively based on the error factor, by randomly selecting the item value pairs to remove from each of the value ranges comprises the second phase which includes:
decreasing the threshold by a predetermined amount;
applying the hash function to the particular item in the particular value range to obtain the random hash function number;
determining that the random hash function number is greater than the threshold decreased by the predetermined amount;
when the random hash function number is greater than the threshold decreased by the predetermined amount, removing the particular item value pair for the particular item from the particular value range; and
respectively repeating the second phase for all of the items in the particular value range resulting in the number of the item value pairs in the particular value range being reduced by randomly removing the item value pairs.

16. The computer program product of claim 9, wherein computing the estimate of the total maximum value of the bids for the item value pairs in all of the value ranges based on the scale factor comprises:
adding the associated values of all the bids in the value ranges for the items to obtain a sum; and
multiplying the sum by the scale factor corresponding to the number of the item value pairs in each of the value ranges that were randomly removed, the scale factor increasing the sum to account for the number of the item value pairs randomly removed.

17-20. (canceled)
